(19) United States
(12) Patent Application Publication
(10) Pub. No.: US 2003/0233493 A1
(43) Pub. Date: Dec. 18, 2003

(54) Firmware installation methods and apparatus

(76) Inventors: John L. Boldon, Emmett, ID (US); Lin-Fat Chris Lee, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/173,326

(22) Filed: Jun. 15, 2002

(51) Int. Cl. G06F 3/00

(52) U.S. Cl. 710/1

(57) ABSTRACT

Methods and apparatus to facilitate prevention of the installation of incompatible firmware components into a firmware-supported device. Methods include performing an automatic firmware dependency compatibility check in conjunction with an attempted installation of firmware components into the firmware-supported device. Apparatus include a firmware bundle having one or more firmware components and which also has a firmware compatibility identifier that is configured to facilitate the performance of the automatic firmware dependency compatibility check. Other apparatus include a firmware-supported device that comprises a firmware component dependency compatibility algorithm that is configured to prevent the installation of incompatible firmware components into the firmware-supported device.

### FIELD OF THE INVENTION

The invention claimed and disclosed herein pertains to firmware, and more specifically to methods and apparatus for preventing incompatible firmware components from being installed into a firmware-supported device.

### BACKGROUND OF THE INVENTION

Many prior art devices are known in which digital processors and the like are employed to facilitate operation of the device. The number of types of such devices is nearly limitless, and such devices can include, for example, industrial equipment, automobiles, telecommunication devices, digital cameras, and the like. Such devices generally employ one of a number of types of ROM (Read Only Memory) devices. ROM devices are memory devices that are often in the form of a solid-state memory device, or “chip.” The ROM device is usually employed to contain code, or instructions, which are accessed by the processor and which are necessary for the processor to function and facilitate operation of the device associated with the processor.

This code, or instructions, contained in the ROM is generally referred to as “firmware.” The firmware is distinguishable from other types of instructions, such as software, in that the firmware generally is configured to facilitate basic operation of the processor itself, and/or related components, while most other types of instructions, such as software, are configured to facilitate the end use of the processor. For example, if a processor were a part of a personal computer, then firmware would be employed to operate the processor and perform other basic functions (such as data routing and data input-output functions). On the other hand, software would be employed to perform such functions as word processing and the like.

In early, or basic, configurations, ROM devices cannot be reprogrammed. That is, the firmware contained in early, or basic ROM device configurations is permanent and cannot be changed or updated. An example of such a ROM device is a PROM (Programmable Read Only Memory) in which the firmware is permanently fixed, or “burned,” onto the PROM using a programming console, for example. However, in newer, or more advanced, forms of ROM devices, the instructions or code that are encoded thereon can be reprogrammed or updated.

These re-programmable types of ROM devices include EPROM (Erasable Programmable Read Only Memory) devices, OTPROM (One Time Programmable Read Only Memory) devices, EEPROM (Electrically Erasable Programmable Read Only Memory) devices, and flash EPROM (similar to EEPROM except that all memory cells in flash EPROM can be erased simultaneously) devices. Such capability of accepting upgraded instructions, as provided by these newer, more advanced ROM devices, can prove advantageous in several ways. For example, if a bug (problem) exists in the firmware, the bug can be fixed by installing corrected bug-free firmware into the ROM. Similarly, for example, if newer, more efficient firmware is developed for an older device, the newer firmware can be loaded into the ROM, thus replacing the older, outdated firmware with updated firmware.

In relatively complex devices, the firmware that is employed to facilitate operation of the device is often divided into several discreet “components.” That is, the firmware in a device can be divided into several sections or components, wherein each firmware component is generally exclusively associated with the performance of a specific task or group of tasks. For example, one type of prior art device in which firmware components can be employed is that of a printer, or copier. A printer or copier can comprise several discreet operating units including, for example, an operating unit called an imaging unit. The imaging unit is for producing an image and depositing the image on a sheet of paper or the like. The printer or copier can also include other operating units such as a finishing unit, for example, for performing collating, stapling, and the like of imaged sheet media.

Likewise, the firmware that is employed in the printing or copying device can consist of several firmware components, wherein each firmware component is associated with the operation of a respective operating unit. For example, in a printer having an imaging unit and a finishing unit, one of the firmware components can be associated with the operation of the imaging unit, while a second firmware component can be associated with the operation of the finishing unit.

Each of these firmware components can be stored on a ROM chip. The ROM chip can be of the re-programmable type such as an EEPROM chip or a flash EPROM chip. Thus, each of the firmware components in the device can be updated such as in a case wherein more efficient firmware is developed. Furthermore, new firmware components can be added to the device to facilitate additional operational tasks associated with the addition of, or retrofit of, an additional operating unit to the device. For example, a duplexing unit can be retrofitted, or added, to a printer that was not previously equipped with a duplexing unit. In such a case, a new firmware component can be correspondingly added to the printer to support the operation of the retrofitted duplexing unit.

In most cases, the various firmware components of a given device communicate with one another in support of the operation of the device. That is, even though a given firmware component can be described as a discreet section of the firmware, the operation of the firmware components together as a whole, and thus also the operation of the supported device, is generally dependent upon the interaction, or interdependency, between most, if not all, of the individual firmware components.

More specifically, at least some of the firmware components of a supported device generally depend upon other firmware components of the supported device in order to function. For example, in the case of a firmware-supported device that runs a JAVA applet, one of the firmware components is the JAVA applet, while another of the firmware components is a JAVA Virtual Machine (“JVM”) that supports the functionality of the JAVA applet. In such a case, the operation of the JAVA applet, as well as that of the supported device, can be dependent upon the compatibility of, and communication between, the JAVA applet and the JAVA Virtual Machine.

Because of the functional dependencies that exist with regard to firmware components of a given supported device, the operation of the firmware, as well as that of the supported device, is sensitive to changes to the firmware. Such changes to the firmware can include, for example, firmware upgrades and added firmware components as mentioned above. That is, if a firmware upgrade or an additional firmware component is installed into a given firmware component, the result can be an incompatibility between interdependent firmware components. This can be due to the fact that certain versions of firmware components are compatible with only certain versions of other firmware components, among other reasons.

Using the example from above, if a firmware update is installed to update a JAVA applet, the update can render the JAVA applet incompatible with the JAVA Virtual Machine on which the JAVA applet is functionally dependent. That is, while certain versions of given firmware components can operate in conjunction with one another, certain other versions of the given firmware are not operationally compatible with one another. In other words, with regard to the above example, even though the supported device may have been previously operating properly, the JAVA applet will not function properly, and thus nor will the supported device, after the installation of an upgrade that is incompatible with one or more other firmware components. Moreover, in some cases, the entire supported device can be rendered permanently inoperable as the result of an incompatible upgrade that is installed in a firmware component.

Turning now to FIG. 1, a schematic diagram is shown which depicts a prior art firmware apparatus 10. The prior art firmware apparatus 10 comprises a memory device 12, and an interface means 14. The apparatus 10 also comprises a plurality of firmware components 16 that are stored in the memory device 12. An upgrade firmware component 17 is to be installed so as to upgrade one of the firmware components 16. An additional firmware component 19 is to be installed as well. The memory device 12 can be any known memory device such as an EEPROM, a flash EPROM, or the like.

The interface means 14 can comprise a RAM (Random Access Memory) (not shown), and/or a firmware upgrade control program or the like (not shown). As is seen, the upgrade firmware component 17 and the additional firmware component 19 pass through the interface means 14 before being loaded into the memory device 12. The interface means 14 can thus perform functions associated with loading the firmware components 17 and 19 into the memory device 12, such as routing functions and the like.

Turning now to FIG. 2, a schematic diagram is shown which depicts a prior art firmware-supported device 50 that is shown in the form of an imaging device. Although the prior art device 50 is specifically depicted as an imaging device, and more specifically as a printer, it is understood that the principles discussed with respect to the prior art device can be applied to nearly any of a number of types of known devices which employ firmware. As shown, the firmware apparatus 10 can be located within the device 50. An operator of the device 50 can manually input various commands into the device, and/or receive information from the device, by way of an operator interface 41 or the like.

The upgrade firmware component 17, as well as the additional firmware component 19 can be made available for installation into the firmware apparatus 10 from a firmware source 60. The firmware source 60 can be, for example, an Internet server, a personal computer, a digital electronic data media (e.g. a floppy disk, a compact disk, a memory chip, etc.), or the like. That is, the upgrade firmware component 17 and the additional firmware component 19 can be installed into the firmware apparatus 10 from any of a number of various sources by way of the Internet, direct installation on a digital electronic data media, from a personal computer via local area network, or the like.

As mentioned above, with respect to the prior art, the installation of upgrade firmware components and/or additional firmware components, such as components 17 and 19 respectively, can result in problems associated with the operation of the device 50. That is, if any of the firmware components to be loaded into the device 50, such as components 17 and 19, are incompatible with the existing firmware components resident in the device, then operational problems are likely with respect to the device.

Such operational problems can be due to disruption or prevention of the interaction between the various firmware components 16 which facilitate the operation of the device as the result of the introduction of incompatible firmware components as discussed above. That is, as explained above, various firmware components 16 can depend on communication and interaction with each other for successful operation. If an upgrade firmware component 17, or an additional firmware component 19, is installed into the memory device 12, then the deoendency between the firmware components can be deleteriously affected if the upgrade or additional firmware component is not totally compatible with other respective firmware components.

Operators of prior art devices, such as the prior art device 10, often desire to install upgrade firmware components 17, and/or additional firmware components 19 into the device for various reasons. These reasons can include the desire to maintain the most current and efficient firmware versions, and the desire to support retrofitted operating units or systems. When such firmware installations are considered, the operator must manually check for incompatibilities with respect to firmware components that are to be installed. That is, when installing an upgrade firmware component and/or an additional firmware component, the operator must manually check for potential firmware dependency incompatibilities which may exist with regard to such firmware installations.

Such manual checking for potential firmware dependency incompatibilities can, in some cases, be extremely difficult to successfully complete, particularly for an unskilled operator of the device. Furthermore, if a mistake is made in such a firmware compatibility checking procedure, then the device into which an incompatible firmware component is mistakenly installed can be rendered inoperable, which in most cases can be rectified only by relatively complex repair procedures that can include, for example, removal and replacement of the entire firmware apparatus 10.

What is needed then are information system methods and apparatus which achieve the benefits to be derived from similar prior art methods and/or devices, but which avoid the shortcomings and detriments individually associated therewith.

### SUMMARY OF THE INVENTION

The present invention provides for methods and apparatus to prevent inadvertent installation of incompatible firmware components into a firmware-supported device. In accordance with one embodiment of the present invention, a method comprises automatically checking firmware component dependency compatibility in conjunction with installation of firmware components, including firmware upgrades and additional firmware components. Such automatic firmware compatibility checking can substantially decrease the likelihood that incompatible firmware components are installed into a firmware-supported device as compared to prior art methods of manually checking.

In accordance with various embodiments of the present invention, the automatic firmware compatibility check in accordance with the present invention can be facilitated by encoding firmware dependency compatibility data within a firmware memory device. In accordance with one specific embodiment of the present invention, a firmware bundle includes an associated firmware dependency compatibility identifier which contains data configured to facilitate the automatic firmware compatibility check. In accordance with yet another embodiment of the present invention, a firmware-supported device includes a memory device in which firmware components are stored, and a firmware dependency compatibility algorithm that is also stored in the memory device, wherein the algorithm can facilitate the automatic firmware compatibility check.

These and other aspects and embodiments of the present invention will now be described in detail with reference to the accompanying drawings, wherein:

### DESCRIPTION OF THE DRAWINGS

FIG. 1 is a schematic diagram which depicts a prior art firmware memory device along with prior art firmware components.

FIG. 2 is a schematic diagram which depicts a prior art firmware-supported device which incorporates the prior art firmware memory device and firmware components shown in FIG. 1.

FIG. 3 is a schematic diagram which depicts a firmware memory device and firmware components, along with a firmware dependency compatibility identifier in accordance with an embodiment of the present invention.

FIG. 4 is a schematic diagram which depicts a firmware dependency compatibility identifier in the form of a data string in accordance with an embodiment of the present invention.

FIG. 5 is a schematic diagram which depicts a firmware-supported device in accordance with an embodiment of the present invention.

FIG. 6 is a flow chart which depicts the steps in a method of performing an automatic firmware compatibility check in accordance with an embodiment of the present invention.

### DETAILED DESCRIPTION OF THE INVENTION

Methods and apparatus in accordance with an embodiment of the present invention are intended to facilitate prevention of inadvertent installation of incompatible firmware components into a firmware-supported device. Such methods and apparatus include a method of automatically checking firmware component dependency compatibility in conjunction with the installation of firmware components. Other methods in accordance with various embodiments of the present invention include encoding firmware dependency compatibility information within a firmware storage device, and associating a firmware compatibility data string with a firmware component.

Methods in accordance with another embodiment of the present invention include providing a firmware memory device, storing a plurality of firmware components in the firmware memory device, and storing firmware component dependency data in the firmware memory device. In accordance with yet another embodiment of the present invention, a firmware bundle includes a firmware component to be installed into a firmware-supported device, and a firmware compatibility identifier that is configured to facilitate identification of potential firmware interdependency incompatibility prior to installation of the firmware component.

In accordance with still another embodiment of the present invention, a firmware-supported device includes a memory device in which a plurality of interdependent firmware components are stored. The device also includes a firmware dependency compatibility algorithm that is stored in the memory device, wherein the algorithm is configured to prevent incompatible firmware components from being installed into the memory device.

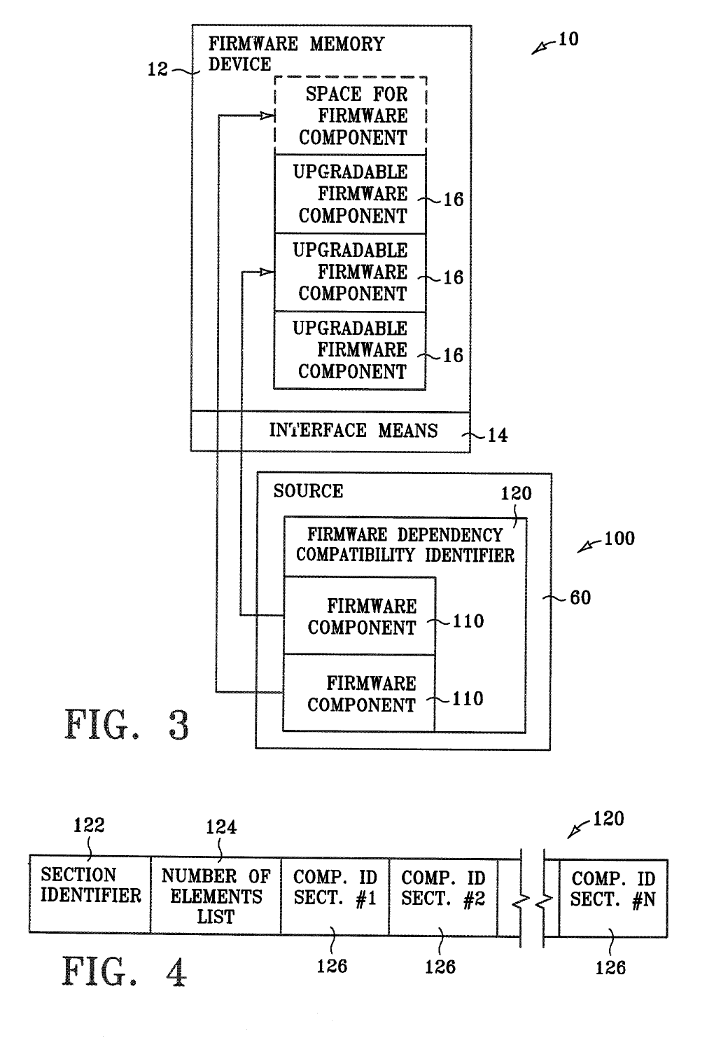

Turning now to FIG. 3, a schematic diagram is shown which depicts a firmware apparatus 10 and a firmware bundle 100 in accordance with one embodiment of the present invention. The firmware apparatus 10 has been described above with respect to the prior art. The firmware bundle 100 incorporates features of the present invention and is configured to be used in conjunction with the apparatus 10 as will be described in greater detail below.

As is further shown, the firmware apparatus 10 comprises a firmware memory device 12 and an interface means 14 which have each been explained above with respect to the prior art. As is also shown, the firmware memory device 12 is configured to store therein at least one upgradeable firmware component 16. The firmware memory device 12 can be a portion of a firmware-supported device (not shown). The upgradeable firmware component 16 has also been described above with respect to the prior art.

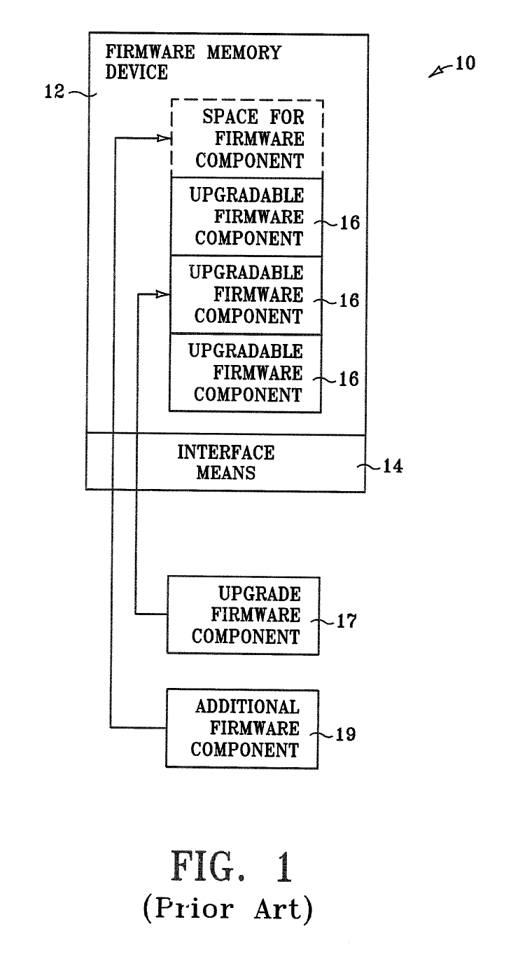

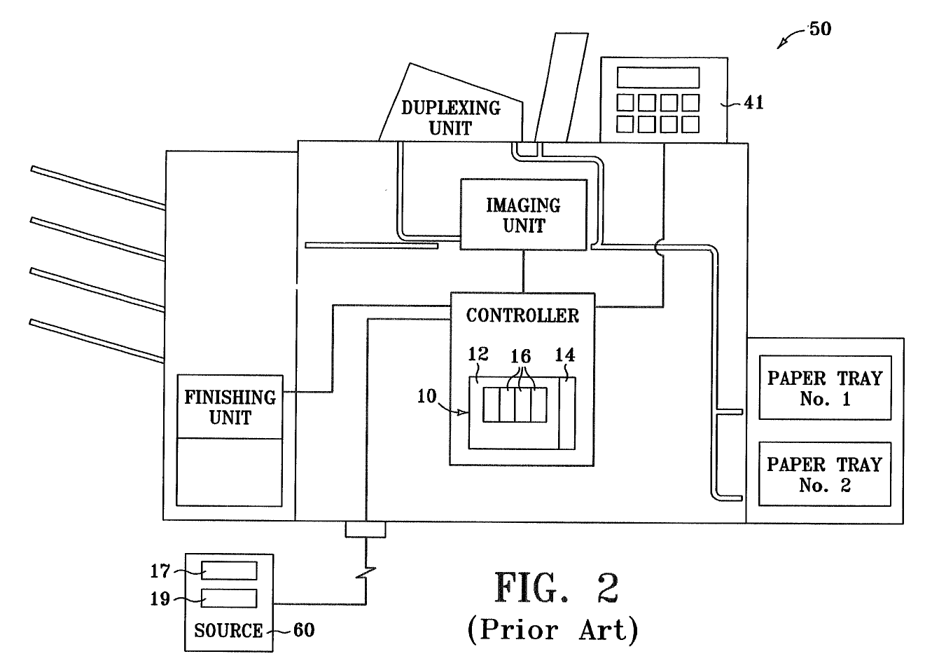

The firmware bundle 100 comprises at least one firmware component 110, as well as a firmware dependency compatibility identifier 120 which will be described below. The firmware component 110 can be, for example, an upgrade firmware component such as the upgrade firmware component 17 shown in FIGS. 1 and 2, and described above with respect to the prior art.

Alternatively, the firmware component 110 shown in FIG. 3 can be an additional firmware component such as the additional firmware component 19 shown in FIGS. 1 and 2, and described above with respect to the prior art. The firmware bundle 100 can originate from the source 60 which has been described above with respect to the prior art. The source 60 can incorporate one of a number of known firmware memory devices (not shown) which are described above with respect to the prior art.

Still referring to FIG. 3, the firmware component 110 is configured to be loaded, or installed, into the firmware memory device 12. In other words, the firmware component 110 can be a full or partial replacement with respect to one of the upgradeable firmware components 16 that are stored in the firmware memory device 12.

Alternatively, the firmware component 110 can be a new, or additional, firmware component that is added to the existing upgradeable firmware components 16. That is, the firmware component 110 can be an entirely new, previously uninstalled, firmware component or an upgrade to an existing, previously installed, firmware component.

The firmware dependency compatibility identifier 120 is associated with each firmware component 110 of the firmware bundle 100. The firmware dependency identifier 120 is configured to contain information indicative of each associated firmware component 110, wherein such information is configured to be employed to automatically check for dependency compatibility between the firmware components of the firmware bundle 100 and the upgradeable firmware components 16 stored in the firmware memory device 12 into which the firmware components of the firmware bundle are configured to be installed.

The term “automatically,” as used herein, means the performance of a task by way of machine processes that are independent of human thought processes. Thus, the firmware dependency compatibility identifier 120 is configured to facilitate compatibility dependency analysis by machine process prior to the loading, or installation, of the firmware components 110 into the firmware memory 12.

For example, the interface means 14 can be configured to automatically read the information contained in the firmware dependency compatibility identifier prior to, and in conjunction with, an attempted loading or installation process with regard to the associated firmware components 11C. In this manner, the firmware dependency compatibility identifier 120 can facilitate automatically checking for dependency compatibility between the associated firmware components 110 to be loaded, and those upgradeable firmware components 16 which have been previously loaded, into the firmware memory device 12.

Thus, firmware dependency compatibility identifier 120 is configured to automatically prevent inadvertent loading, or installation, of associated firmware components 110 that can be incompatible with existing upgradeable firmware components 16 which have been previously installed into the firmware memory 12. Stated in yet another way, the firmware compatibility identifier 120 is configured to automatically allow the loading, or installation, of associated firmware components 110 only if the firmware components are determined to be compatible with the upgradeable firmware components previously installed into the firmware memory 12. Such performance of automatic firmware dependency compatibility analysis is facilitated by the firmware dependency compatibility identifier 120 that is associated with the firmware components 110 which are intended to be loaded into the firmware memory device 12.

The firmware dependency compatibility identifier 120 can be configured in one of many possible forms, including that of a data string. A data string can be, for example, a line of code, such as hexadecimal machine code or the like. Moving now to FIG. 4, a schematic diagram is shown which depicts the firmware dependency compatibility identifier 120 in accordance with one embodiment of the present invention, wherein the firmware dependency compatibility identifier is shown in the form of a data string. As is seen, the firmware dependency compatibility identifier 120, when in the form of a data string, can comprise a section identifier 122, a number of elements list 124, and at least one component identification section 126.

Preferably, the section identifier 122 is configured to identify the data string as a firmware dependency compatibility identifier. That is, preferably, the firmware dependency compatibility identifier 120, when in the form of a data string having a section identifier 122, is configured such that the section identifier is the first portion of the firmware dependency compatibility identifier to be read by a reading device such as a controller (not shown) or the like. Thus, being the first portion of the firmware dependency compatibility identifier 120 to be read, the section identifier 122 notifies the reading device (not shown) that firmware dependency compatibility information is to follow. After first reading the section identifier 122, the reading device is then prepared to read and process the remainder of the firmware dependency compatibility identifier 120.

The next portion of the firmware dependency compatibility identifier 120 to be read is preferably the number of elements list 124. The number of elements list 124 is preferably configured to indicate the number of firmware components 110 (shown in FIG. 3) in the firmware bundle 100 (shown in FIG. 3) with which the firmware dependency compatibility identifier 120 is associated. The association of the firmware dependency compatibility identifier 120 with the respective firmware components 110 is explained above with respect to FIG. 3.

That is, as explained above, the firmware dependency compatibility identifier 120 is associated with the firmware components 110 as shown in FIG. 3, whereby the firmware dependency compatibility identifier provides information indicative of the associated firmware components in order to facilitate an automatic firmware dependency compatibility check with regard to the firmware components in conjunction with, and prior to, installation of the firmware components into a device such as a firmware memory device 12 or the like. Preferably, the firmware compatibility identifier is developed, or originates, with the firmware developer or publisher, or other like entity.

Still referring to FIG. 4, the next portions of the firmware dependency compatibility identifier 120 to be read are the component identification sections 126. Preferably, the firmware dependency compatibility identifier 120, in the case wherein the firmware dependency compatibility identifier is in the form of a data string, comprises up to and including N number of component identification sections 126, wherein N is the number of firmware components 110 (shown in FIG. 3) which are included in the firmware bundle 100 (shown in FIG. 3) and with which the data string is associated.

For example, if two firmware components 110 are included in a given firmware bundle 100, then preferably the firmware dependency compatibility identifier 120, in the form of a data string, comprises two component identification sections 126. That is, each component identification section 126 is preferably associated in one-to-one correspondence with each firmware component 110 included in the associated firmware bundle 100. More specifically, in the case wherein a firmware bundle 100 comprises a first and a second firmware component (not shown), then a first component identification section (not shown) is exclusively associated with the first firmware component and a second component identification section is exclusively associated with the second firmware component.

Also, each component identification section 126 is preferably configured to identify at least one characteristic of the respective associated firmware component 110. That is, for example, a given component identification section 126 that is associated with a given firmware component 110 is preferably configured to contain information indicative of at least one characteristic of the given firmware component. For example, a characteristic of a firmware component 110 can be the name of the firmware component, or some other similar type of unique identifier of the respective firmware component. In this manner, each of the firmware components 110 which are included in a given firmware bundle 100 can be identified prior to installation thereof in order to facilitate an automatic firmware dependency compatibility check.

That is, by way of example, the firmware dependency compatibility identifier 120, which can be in the form of a data string, can be automatically read prior to, and in conjunction with, the installation of associated firmware components 110. Information gleaned from such an automatic reading of the data string can then be automatically processed and/or analyzed by way of an algorithm or the like (not shown), whereby an automatic firmware dependency compatibility check is performed. In other words, the firmware dependency compatibility identifier 120, in the form of a data string, is preferably configured to be read and processed in conjunction with, and prior to, loading of the firmware bundle 100 into a firmware memory device such as the firmware memory device 12 (shown in FIG. 3).

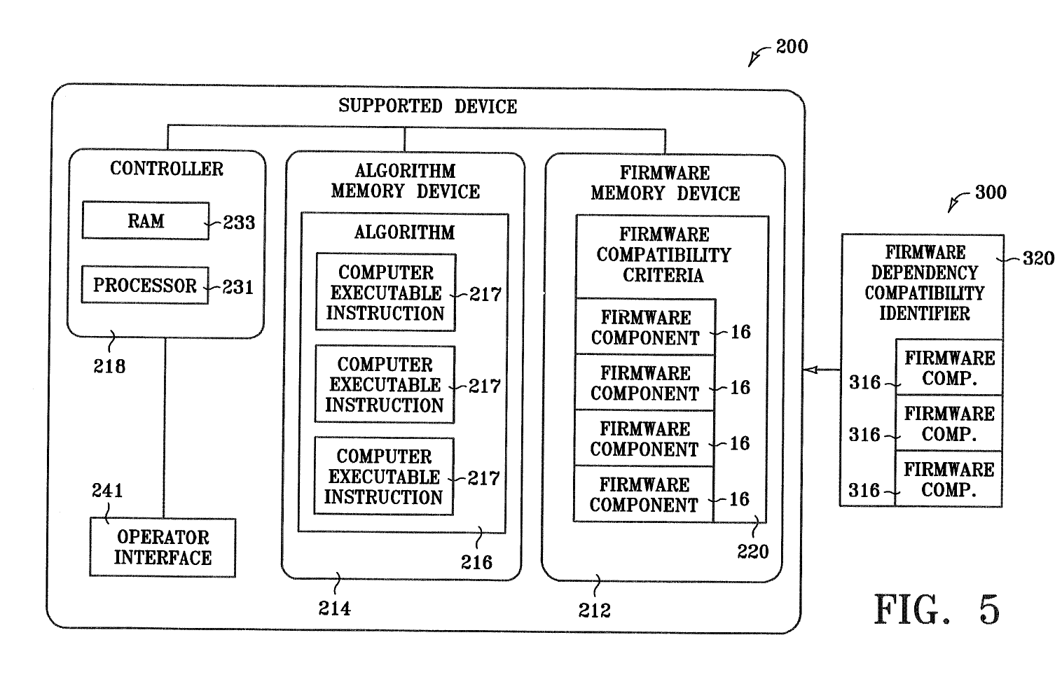

Turning now to FIG. 5 a schematic diagram is shown in which a firmware-supported device 200 is depicted. The supported device 200 can be one of many possible devices that are operationally supported by a plurality of interdependent upgradeable firmware components 16. For example, the supported device 200 can be an imaging device such as a printer, copier, or the like. The firmware components 16 have been explained above with respect to the prior art. As is also seen, a firmware bundle 300 is depicted in FIG. 5 as well.

The firmware bundle 300 which can be similar to the firmware bundle 100 that is shown in FIG. 3 and is described above with respect thereto. As seen, the firmware bundle 300 can comprise at least one incompatible firmware component 316 which will be explained in greater detail below. The firmware bundle 300 also preferably comprises a firmware dependency compatibility identifier 320 which is associated with the firmware components 316 in the manner discussed above with respect to the firmware dependency compatibility identifier 120 and the associated firmware components 110 which are shown in FIG. 3. The firmware bundle 300 and related components which are shown in FIG. 5 will be explained in relation to the supported device 200 in later discussion.

The device 200 comprises a firmware memory device 212 configured to store therein the firmware components 16. The firmware memory device 212 can be similar to the prior art firmware memory device 12 that has been described above with respect to it FIGS. 1 and 2. As is also seen, the device 200 can comprise a set of firmware dependency compatibility criteria 220 which can be in the form of a data string or the like.

The firmware dependency compatibility criteria 220 is associated with the firmware components 16 as in the case of the firmware dependency compatibility identifier 120 described above with respect to FIGS. 3 and 4. That is, the firmware dependency compatibility criteria 220 preferably contain information indicative of the associated firmware components 16 and which can be employed to facilitate an automatic firmware dependency compatibility check which has been explained above.

The device 200 also comprises an algorithm memory device 214. The algorithm memory device 214 is configured to store therein a firmware component dependency compatibility algorithm 216. The device 200 also preferably comprises a controller 218 that is in signal communication with both the algorithm memory device 214 and the firmware memory device 212. The controller 218 preferably includes a random access memory (“RAM”) 233 and a processor 231. The processor 231 is configured to execute computer executable instructions or the like. The configuration and use of controllers, random access memories, and processors is well understood in the art.

The supported device 200 can also comprise an operator interface 241 that is configured to present data to the operator of the device. Preferably, the operator interface 241 is in signal communication with the controller 218. The operator interface 241 can also be configured to allow the operator of the device to enter data into the device. The operator interface 241 can comprise, for example, a visual display and/or a keypad or the like. operator interfaces are known in the art.

The algorithm 216 comprises a series of computer executable instructions 217. The general concept of computer executable instructions is also well understood in the art. The computer executable instructions 217 are preferably configured to be executed by the processor 231 to thereby prevent incompatible firmware components 316 from being loaded into the firmware memory device 212.

In other words, the series of computer executable instructions 217 are preferably configured to be executed by the processor 231 so as to perform an automatic firmware dependency compatibility check. Such an automatic firmware dependency compatibility check can prevent incompatible firmware components 316 from being loaded, or installed, into the firmware memory device 212. The loading of such incompatible firmware components 316 into the firmware memory device 212 can be detrimental to the operation of the device 200.

In operation, the firmware bundle 300, including the firmware dependency compatibility identifier 320 and the associated pre-installation firmware components 316, can be temporarily stored in the random access memory 233 of the device 200. Information contained in the firmware dependency compatibility identifier 320 can then be read from the random access memory 233. Also, information contained in the a firmware dependency compatibility criteria set 220 can be read therefrom.

The computer executable instructions 217 from the firmware dependency compatibility algorithm 216 can then be accessed and executed by the processor 231 to thereby perform an automatic firmware dependency compatibility check before the pre-installation firmware components 316 are loaded into the firmware memory device 212. That is, the processor 231, by executing the computer executable instructions 217 of the algorithm 216, can process and analyze the information contained in the firmware compatibility criteria set 220 and/or the information contained in the firmware dependency compatibility identifier 320 to thereby determine whether the pre-installation firmware components 316 are compatible with the firmware components 16.

If any of the pre-installation firmware components 316 are determined to be compatible with the firmware components 16 as a result of the automatic compatibility check performed by the processor 231, then those pre-installation firmware components that have been determined to be compatible can be installed into the firmware memory device 212. Conversely, if any of the pre-installation firmware components 316 are determined to be incompatible with the firmware components 16 as a result of the automatic compatibility check, then those pre-installation firmware components 316 that have been determined to be incompatible are not installed into the firmware memory device 212.

Alternatively, if any of the pre-installation firmware components 316 are determined to be incompatible with the firmware components 16 as a result of the automatic compatibility check, then none of the pre-installation firmware components 316 are installed in the firmware memory device 212. As yet a further option, the supported device 200 can be configured to notify the operator of a firmware dependency incompatibility which is found as a result of performing an automatic firmware dependency compatibility check. The operator of the device 200 can be thus notified by way of the operator interface 241.

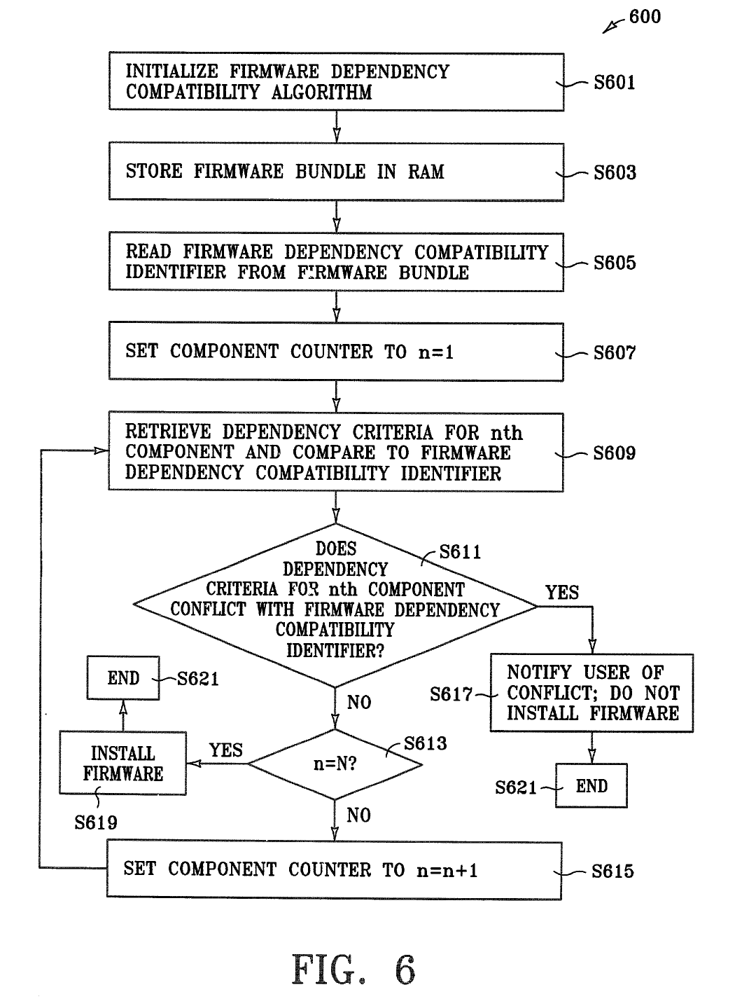

As is evident from the above discussion with regard to FIG. 5, the series of computer executable instructions 217 are configured to be executed by the processor 231 to thereby prevent an incompatible firmware component installation into the firmware memory device 212. Moving now to FIG. 6, a flow diagram 600 is shown in accordance with one embodiment of the present invention. The flow diagram 600 depicts several steps in a method of performing an automatic firmware dependency compatibility check. It is understood that the flow diagram 600 represents but one of many possible specific methods of performing an automatic firmware dependency compatibility check in accordance with the present invention.

In accordance with the first step S601 of the diagram 600, the firmware dependency compatibility algorithm is initialized, thereby readying the algorithm to perform an automatic firmware dependency compatibility check. The firmware dependency compatibility algorithm can be, for example, the algorithm 216 that is shown in FIG. 5 and is described above. The diagram 600 moves to the next step S603 in accordance with which the firmware bundle is stored in the random access memory (“RAM”). The firmware bundle can be, for example, the firmware bundle 300 that is shown in FIG. 5 and is described above. Likewise, the random access memory can be, for example, the random access memory 233 that is shown in FIG. 5 and is described above.

Proceeding to the next step S605 of the diagram 600, the firmware dependency compatibility identifier is read from the firmware bundle that is stored in the random access memory. The firmware dependency compatibility identifier can be, for example, the firmware dependency compatibility identifier 320 that is shown in FIG. 5 and is explained above. The firmware dependency compatibility identifier preferable contains information indicative of the firmware components which are included in the firmware bundle stored in the random access memory. Such information is thus read in accordance with the step S605 of the diagram 600.

The following step S607 of the diagram 600 dictates that the firmware component counter is set to a value of one (1). The firmware component counter keeps track of which of the firmware components in the random access memory is being analyzed by the algorithm. For example, for the first firmware component to be analyzed by the algorithm, the firmware component counter is set to a value of one (1). Similarly, for the second firmware component to be analyzed by the algorithm, the firmware component counter is set to a value of two (2).

Now moving to step S609 of the diagram 600, the dependency criteria for the nth firmware component stored in the random access memory is retrieved and compared to the information that has been read, in step S605, from the firmware dependency compatibility identifier. The dependency criteria is information pertaining at least to the firmware components which were previously installed in the device prior to the commencement of the current automatic firmware dependency compatibility check. The dependency criteria can be, for example, the firmware compatibility criteria 220 that are shown in FIG. 5 and are explained above.

The diagram 600 next moves to the step S611 which queries whether the dependency criteria for the nth firmware component conflicts with the firmware dependency compatibility identifier. That is, in accordance with the step S611, the algorithm is analyzing both the firmware dependency criteria and the information contained in the firmware dependency compatibility identifier in light of one another and with respect to the nth firmware component stored in the random access memory. Stated in yet another way, the algorithm, in accordance with the step S611, is looking for potential dependency compatibility conflicts between the nth firmware component waiting to be loaded, and the previously loaded firmware components.

Depending upon the resolution of the query in accordance with step S611, the diagram moves either to step S613, or to step S617. That is, if the answer to the query of step S611 is that there is no dependency compatibility conflict detected, then the path of the diagram 600 moves to step S613. If, on the other hand, the answer to the query of step S611 is that there is a conflict detected, then the path of the diagram moves to step S617. In accordance with step S617, the user, or operator, of the supported device is notified that a dependency compatibility conflict has been detected, and the firmware of the firmware bundle is not installed in the supported device. From step S617, the diagram 600 moves to the step 3621, whereby the process of the diagram terminates.

In accordance with step S613, another query is resolved. The query of step S613 asks whether the value of the counter is equal to N, wherein N is the total number of firmware components of the firmware bundle stored in the random access memory. That is, in accordance with step S613, the query is whether the last firmware component has been analyzed, since n would be equal to N for the last firmware component. Thus, if the value of the counter is less than N, then more firmware components must be analyzed. On the other hand, if the value of the counter is equal to N, then the last firmware component has been analyzed. Accordingly, if the answer to the query of step S613 is that the counter is equal to N, then the diagram 600 moves to the step S619. Conversely, if the answer to the query of step S613 is that the counter is not equal to N, then the diagram 600 moves to the step S615.

The step S619 stipulates that the firmware components of the firmware bundle are installed in the supported device, since at that point all of the components will have been checked and no dependency compatibility conflicts will have been detected. Proceeding from the step S619, the next step is that of step S621 in accordance with which the process of the diagram 600 is terminated. As explained above, if the answer to the query of step S613 is “no,” then the next step of the diagram 600 is that of S615. In accordance with step S615, the value of the component counter is increased by an increment of one (1). That is, the value of “n” is increased by a value of one (1).

Thus, in accordance with the step S615, the algorithm represented by the diagram 600 advances to the analysis of the next firmware component of the firmware bundle stored in the random access memory. From step S615, the diagram 600 circulates back to step S609 to begin the analysis of the next firmware component. That is, the relevant information is retrieved for the nth firmware component in accordance with step S609, wherein “n” has now been incrementally increased by a value of one (1). The diagram then proceeds to step S611 as described above.

In accordance with another embodiment of the present invention, a method comprises performing an automatic firmware dependency compatibility check in conjunction with installation into a device of an additional firmware component. The term “automatic firmware dependency compatibility check” means to automatically analyze, prior to installation, the firmware components which are to be installed into a device for dependency compatibility with respect to any firmware components which have previously been installed in the device.

Automatic firmware dependency compatibility checks have also been discussed above with respect to FIGS. 3 through 6. The term “additional firmware component” means a firmware component that is not intended to upgrade or otherwise replace any previously installed firmware component. That is, an additional firmware component is a component that is newly added to a supported device in order to support a newly added operational unit, for example.

In accordance with yet another embodiment of the present invention, a method comprises performing an automatic firmware dependency compatibility check in conjunction with installation into a device of an upgrade firmware component. The term “upgrade firmware component” means a firmware component that is intended to upgrade or otherwise replace any previously installed firmware component. Thus, the two terms of “upgrade firmware component” and “additional firmware component” are mutually exclusive with respect to one another.

In accordance with still another embodiment of the present invention, a method comprises encoding firmware dependency compatibility data within a firmware memory device. The term “firmware dependency compatibility data” means any information or criteria that is intended to be employed to facilitate an automatic firmware dependency compatibility check. The term “firmware memory device” means any memory device that is configured to store therein a firmware component.

In accordance with yet an additional embodiment of the present invention, a method includes correspondingly associating a firmware dependency compatibility data string with a firmware component. The term “correspondingly associating” with respect to a first and a second object means to link the first object with the second object in a one-to-one correspondence in such a manner that the first object is identified with the second object, and vice versa. The term “firmware dependency compatibility data string” means a specific type of firmware dependency compatibility data which is in the form of a data string.

In accordance with yet still another embodiment of the present invention, a method includes providing a firmware memory device. The firmware memory device has been explained above. The method also includes storing a plurality of firmware components on the firmware memory device along with correspondingly associated firmware dependency compatibility data. That is, the method includes storing firmware dependency compatibility data on the firmware memory device, wherein the firmware dependency compatibility data is correspondingly associated with a plurality of firmware components which are also stored on the firmware memory device.

The method can also include automatically reading the firmware dependency compatibility data in response to attempting to install an upgrade firmware component into the firmware memory device. The method can further comprise automatically determining whether or not the upgrade firmware component is incompatible with firmware components stored on the firmware memory device.

Additionally, in accordance with the method, the upgrade firmware component is automatically installed into the firmware memory device in response to determining that the upgrade firmware component is not incompatible with the firmware components stored on the firmware memory device. Alternatively stated, the method can include preventing the upgrade firmware component from being installed into the firmware memory device in response to determining that the upgrade firmware component is incompatible with the firmware components stored on the firmware memory device.

As an alternative to attempting to install an upgrade firmware component into the firmware memory device, the method can include attempting to install an additional firmware component into the firmware memory device. Accordingly, the method can also include automatically reading firmware dependency data in response to attempting to install the additional firmware component. The method can also comprise a step of automatically determining whether or not the additional firmware component is dependency compatible with the firmware components stored on the firmware memory device.

Thus, the method can include automatically allowing installation of the additional firmware component into the firmware memory in response to determining that the additional firmware component is dependency compatible with the firmware components stored on the firmware memory device. Alternatively stated, the method includes automatically preventing the installation of the additional firmware component into the firmware memory device in response to determining that the additional firmware component is not dependency compatible with the firmware components stored on the firmware memory device.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method, comprising automatically checking firmware component dependency compatibility in conjunction with installation of firmware components into a firmware-supported device.

2. A method, comprising automatically checking firmware component dependency compatibility when installing firmware component upgrades into a firmware-supported device.

3. A method, comprising encoding firmware component dependency compatibility information within a firmware component memory device.

4. A method, comprising correspondingly associating a firmware component dependency compatibility data string with a firmware component.

5. A method, comprising:
providing a firmware memory device in a firmware-supported device;
storing a plurality of firmware components in the firmware memory device; and,
storing firmware component dependency data in the firmware memory device.

6. The method of claim 5, and further comprising:
attempting to load a firmware component upgrade into the firmware memory device; and,
automatically reading the firmware dependency data in response to attempting to load the firmware component upgrade.

7. The method of claim 6, and further comprising automatically determining whether the firmware component upgrade is dependency compatible with the plurality of firmware components stored in the memory device.

8. The method of claim 7, and further comprising automatically allowing the firmware component upgrade to load into the firmware memory device in response to determining that the firmware component upgrade is dependency compatible with the plurality of firmware components stored in the memory device.

9. The method of claim 7, and further comprising automatically preventing the firmware component upgrade to load in response to determining that the firmware component upgrade is not dependency compatible with the plurality of firmware components stored in the memory device.

10. The method of claim 5, and further comprising:
attempting to load an additional firmware component into the memory device; and,
automatically reading firmware dependency data in response to attempting to load the additional firmware component.

11. The method of claim 10, and further comprising automatically determining whether the additional firmware component is dependency compatible with the plurality of firmware components stored in the memory device.

12. The method of claim 11, and further comprising automatically allowing the additional firmware component to load in response to determining that the additional firmware component is dependency compatible with the plurality of firmware components stored in the memory device.

13. The method of claim 11, and further comprising automatically preventing the additional firmware component from loading in response to determining that the additional firmware component is not dependency compatible with the plurality of firmware components stored in the memory device.

14. A firmware bundle, comprising:
a firmware component that is configured to be installed into a firmware-supported device; and,
a firmware dependency compatibility identifier that is correspondingly associated with the firmware component and that is configured to facilitate identification of potential firmware interdependency incompatibility prior to installation of the firmware into the firmware-supported device.

15. The firmware bundle of claim 14, wherein the firmware component dependency compatibility identifier is a data string.

16. The firmware bundle of claim 15, wherein the data string is configured to be read and processed in conjunction with, and prior to, loading of the firmware bundle into the firmware-supported device.

17. The firmware bundle of claim 15, and wherein the data string comprises:
a section identifier that is configured to identify the firmware upgrade bundle as such;
a number of elements list that is configured to indicate the number of firmware components in the upgrade bundle; and,
at least one component identification section, wherein:
each component identification section is associated in one-to-one correspondence to each firmware component included in the upgrade bundle;
each component identification section is configured to identify at least one characteristic of the respective associated firmware component.

18. A firmware-supported device functionally supported by a plurality of by interdependent firmware components, the device comprising:
a memory device in which the plurality of interdependent firmware components are functionally stored;
a firmware component dependency compatibility algorithm functionally stored in the memory device, wherein the algorithm comprises a series of computer executable instructions configured to be executed by a processor to prevent potentially incompatible firmware components from being loaded into the memory device.

19. The device of claim 13, and wherein the apparatus is an imaging device.

20. The device of claim 18, and further comprising a firmware component dependency compatibility identifier in the form of a data string that is stored in the memory device.
